(19) United States
(12) Patent Application Publication
(10) Pub. No.: US 2010/0269434 A1
(43) Pub. Date: Oct. 28, 2010

(54) MULTI-MEASUREMENTS DOOR FRAME

(76) Inventor: Jose Genaro Contreras de la Pena, Moreila (MX)

Correspondence Address: INTELLECTUAL PROPERTY / TECHNOLOGY LAW, PO BOX 14329, RESEARCH TRIANGLE PARK, NC, 27709, US

(21) Appl. No.: 12/670,274

(22) PCT Filed: Jul. 23, 2008
(86) PCT No.: PCT/MX08/00097

§ 371 Date: Jul. 6, 2010

(30) Foreign Application Priority Data
Jul. 25, 2007 (MX) MX/U/2007/000242

(51) Int. Cl. E06B 1/52

(52) U.S. Cl. 52/217

(57) ABSTRACT

This invention concerns a door frame with the option of having several dimensions in a single door, these measurements being set and defined by the inner jambs. This invention provides a type of door frame totally different from those currently on the market, due to a design and novel interior construction and wherein the principal characteristic is that it has a series of inner jambs which can resize this door frame to several measurements, achieving manufacture thereof at a low cost and supplying the range of measurements required in the market.

### OBJECT OF THE INVENTION

This invention concerns a multi-measurement frame, specifically in order to be able to resize the door according to the needs of the various measurements of hollow doors and/or other products that are built using the same principles as this type of frame.

### BACKGROUND OF THE INVENTION

Currently the frames used in the manufacture of hollow doors are principally built of wood. These doors are of fixed preset measurements. Their construction and structure do not allow resizing, so the frame itself offers a door that may be resized to several measurements.

This limiting factor in the existing frames forces distributors to maintain a broad and varied inventory in order to cover the needs for the measurements that the market requires and also they cannot be sure of having equal movement in sales of each of the different door measurements, which may produce an inventory with little or no turnover and over time the door may suffer physical deterioration which will require that the door be:

auctioned, returned to the manufacturer, or become
a total loss, causing great losses for the distributor in the first case and in the second for the manufacturer.

For the purpose of eliminating these and other disadvantages, this multi-measurement frame was thought of for development, the protection of which is sought via this application. The characteristics of this invention have been designed to resolve this problem or limiting factor in frames made into doors [SIC] existing on the market. It is for this reason its main characteristic focuses on the fact that the frame itself may be resized to different measurements, making it possible to cover with just one door the different measurements required on the market with equal or greater strength in its structure than traditional doors. This allows both the distributor as well as the manufacturer to not have slow or dead inventory and with a smaller inventory they can cover all the needs of the market, for example; a distributor purchases 100 conventional doors, divided in groups in the measurements required by the market (20 of one measurement, 10 of another measurement, 15 of another measurement, etc.), but with this frame system he would have 100 doors of each measurement, since each one of these multi-measurement frames will adapt to all the measurements established in the market with one simple cut.

### DESCRIPTION OF THE FIGURES

FIG. 1.—Shows a front, side, and top view of the multi-measurement frame.

FIG. 2.—Shows an exploded front view showing the components of the multi-measurement frame.

FIG. 3.—Shows a front view with the variant of several sizing jambs on both sides.

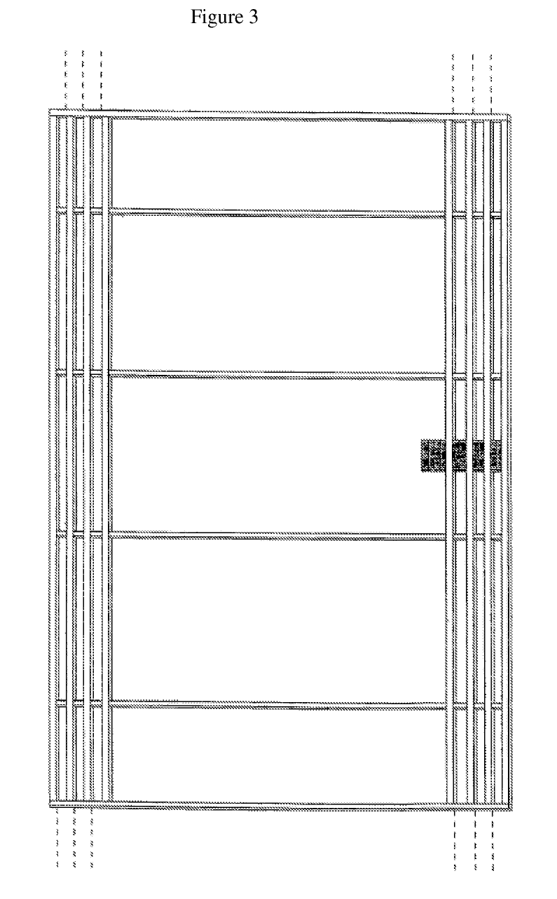

FIG. 4.—Shows a front view with the variant of one single sizing jamb on both sides.

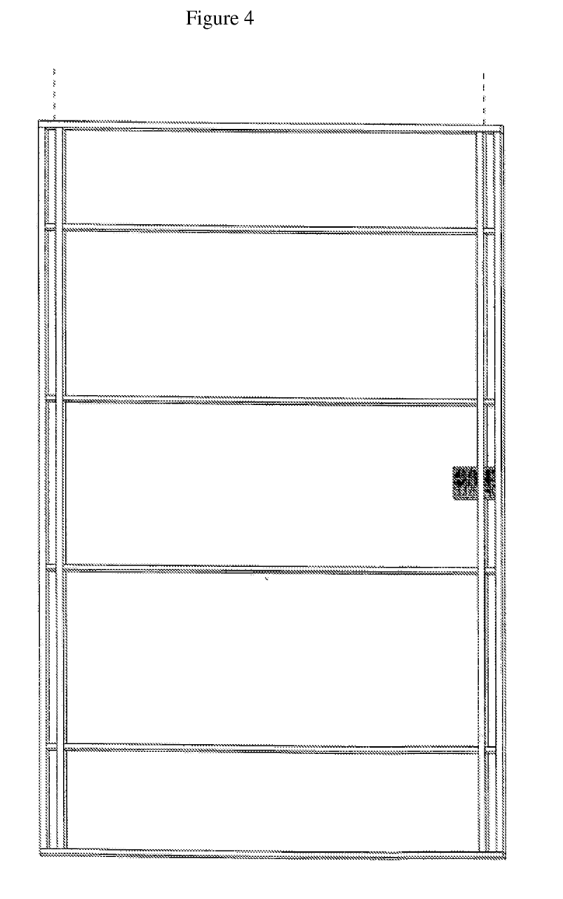

FIG. 5.—Shows a front view with the variant of several sizing jambs on one single side.

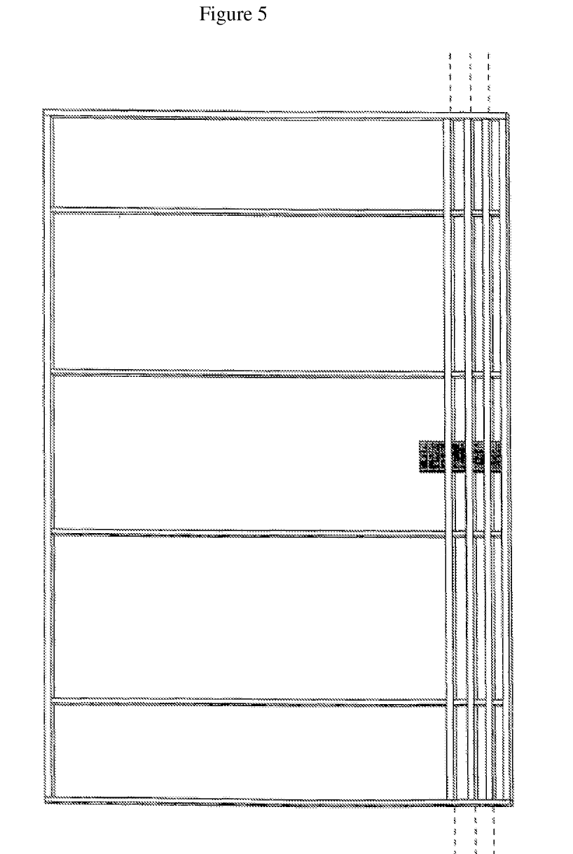

FIG. 6.—Shows a front view with the variant of one single sizing jamb on one side only.

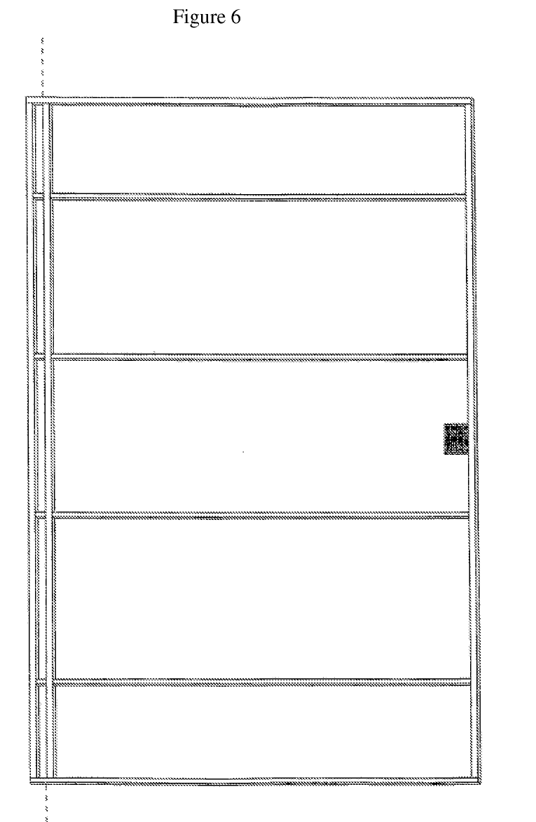

FIG. 7.—Shows sections of the multi-measurement frame assembly.

FIG. 8.—Shows the placement of the wood for the lock mechanism of the door.

### DESCRIPTION

To complete the description given here and for the purpose of helping to provide better understanding of the characteristics of the invention and its variations, I have accompanied the following description with drawings (for the purpose of illustration and not of a restrictive nature) as an integral part of this description, showing its structure, method of assembly, and components.

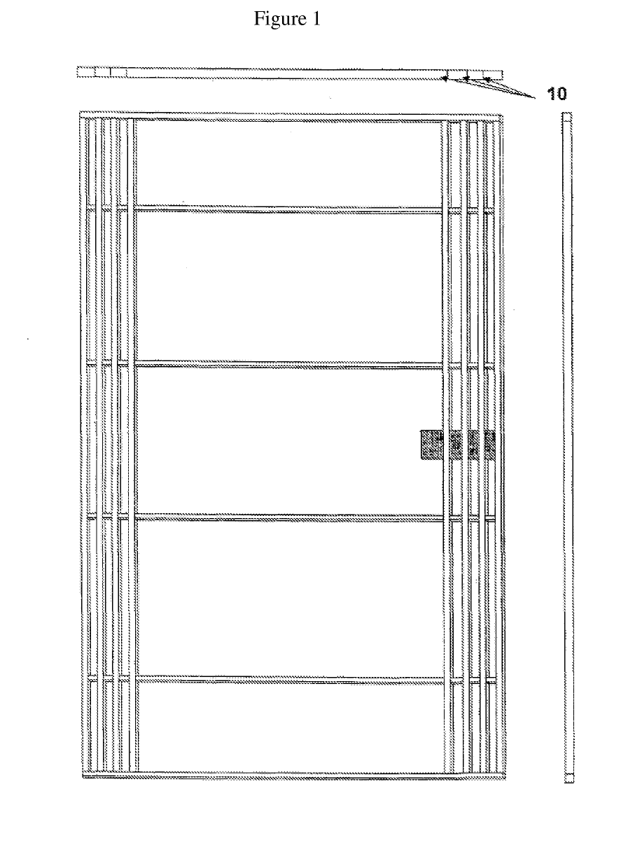

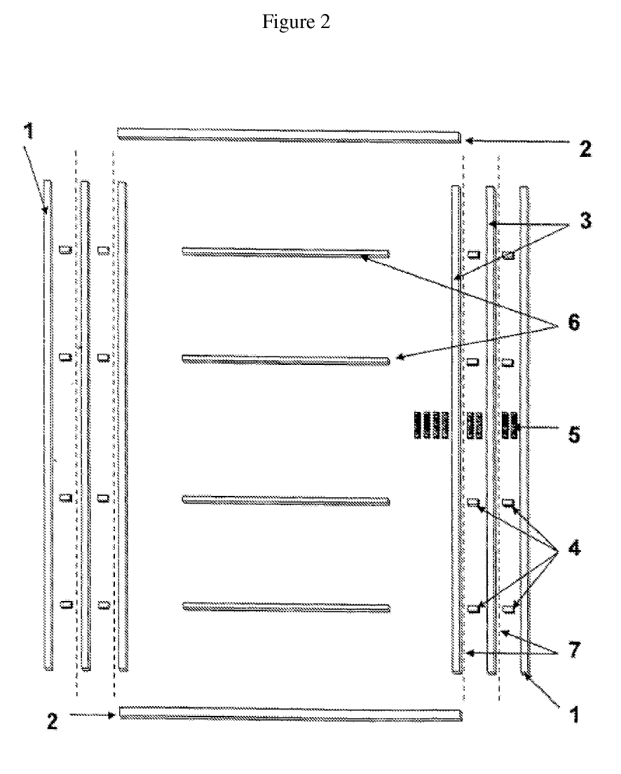

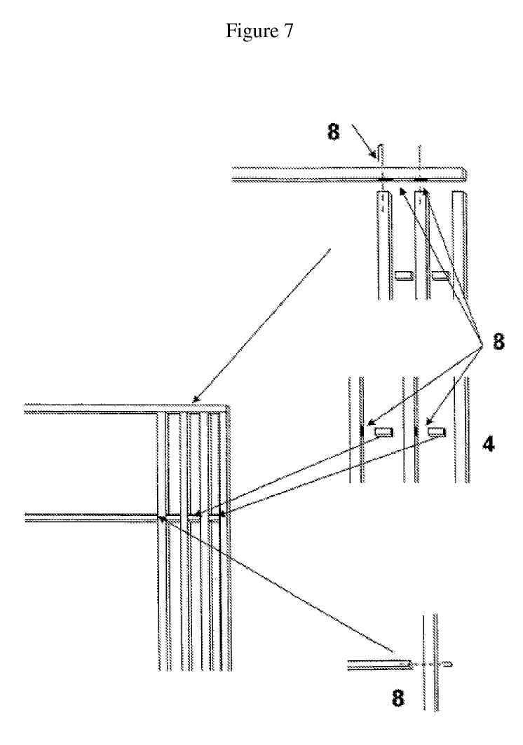

The structure of the multi-measurement frame is comprised of 4 exterior square posts; two vertical jambs (1) and two horizontal crossbeams (2) (FIG. 2) chiefly made of wood and fixed on the ends with a nail and/or staple accompanied by an adhesive and/or a chemical substance (FIG. 7, No. 8) forming a rectangle of the required dimensions, with the exterior horizontal crossbeams (2) being those that show the measurements through a mark indicating where to cut the frame (FIG. 1, No. 10). After the exterior jambs (1) the interior jambs (3) are put in place leaving a space between jamb and jamb in succession being this the first characteristic of the multi-measurement frame. The number of interior vertical jambs (3) depends on the amount of measurements that you want the frame to have and with one cut on the cut mark (10-7) a new measurement will exist without this affecting its structure or rigidity, with the most commercial of the measurements on the market being from 5 to 5 centimeters starting at from 90 to 60 centimeter [SIC], without these being the only measurement option and showing some variations on the placement of the interior jambs and without this affecting the rigidity and structure of the door (Figure No. 3 to 6). In the space between the jambs some small spacers (4) are added (FIGS. 2 and 7/No. 4) which may be of wood, to provide immobility and firmness to the interior jambs (3), since wood is the main material used for this type of jambs and because of changes in temperature and/or humidity they tend to undergo modifications (very slight movement) producing as a result variations in the measurements and reducing the quality of the frame. Upon the lowest vertical jambs horizontal crossbeams (6) are fixed to give structure and rigidity to the frames which are attached with a nail and/or staple accompanied by an adhesive or a chemical substance (8) occasionally substituted by a cardboard grid which serves the same function.

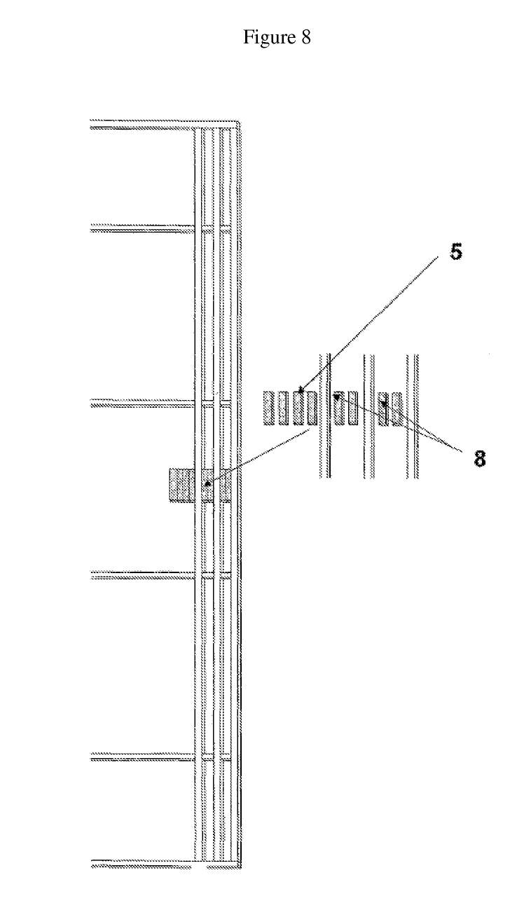

Once the frame is assembled a section is also added that is chiefly made of wood to give area for placement of the lock (5) placement and location on the frame [SIC] (FIGS. 2 and 8) to finish covering it with triply plywood and/or any other laminated material or with die cast covers which are attached to the frame using an adhesive and/or a chemical substance, nails, or staples (8).

No matter what measurements are used to adjust the door, its structure and rigidity is not reduced even when using the largest measurements, its structure and rigidity is significantly greater than any other hollow door because in addition to resizing, a secondary function is provided due to the vertical interior jambs (3) reinforcing the structure of the door.

All the jambs, crossbeams, and components of the frame may be of the thickness, measurements, amount, and proportions needed to make its structure, measurements, and quality exactly right to provide an optimal performance, both in the cost and the functionality that each market demands. The elements used to assembly the frame may also vary. In some cases the wood used in manufacturing the door is substituted by more economical materials in order to reduce cost.

It was reported that results obtained from various factory performed tests on the structure, assembly, and operation were totally satisfactory.

1.-5. (canceled)

6. A multi-dimensional door frame comprising:
a) a top and bottom horizontal crossbeams, each comprising left and right ends,
b) a left and right exterior vertical jambs, each comprising a top and a bottom end, wherein:
i) the top end of the left exterior vertical jamb is attached to the left end of the top horizontal crossbeam,
ii) the bottom end of the left exterior vertical jamb is attached to the left end of the bottom horizontal crossbeam,
iii) the top end of the right exterior vertical jamb is attached to the right end of the top horizontal crossbeam,
iv) the bottom end of the right exterior vertical jamb is attached to the right end of the bottom horizontal crossbeam, and
v) one or both of the exterior horizontal crossbeams include measurements which are marked to indicate a cutting area on the frame,
c) one or more internal vertical jambs, which are spaced at a predetermined distance either from an exterior vertical jamb or from another interior vertical jamb,
d) a plurality of spacers that attach the interior vertical jamb(s) either to an adjacent exterior vertical jamb or to an adjacent interior vertical jamb,
e) a plurality of horizontal crossbeams connecting the leftmost vertical jamb present on the right side of the door frame to the rightmost vertical jamb present on the left side of the door frame, and
f) an assembly of wood adjacent to one of the left or right jamb sufficient to receive a door lock.

7. The door frame of claim 6, further comprising a covering selected from the group consisting of plywood and die cast covers.

8. The door frame of claim 7, wherein the frame covers are attached using adhesives, chemical substances, nails, or staples.

9. The door frame of claim 6, wherein the jambs and crossbeams are attached to each other using nails, staples, adhesives, or chemical substances.

10. The door frame of claim 9, wherein the vertical jambs are attached to the horizontal crossbeams with removable fasteners.

11. The door frame of claim 6, wherein the individual frame components of the frame are selected from the group consisting of wood, plywood, composite materials, and plastic.

12. The door frame of claim 6, wherein only one of the exterior vertical jambs is attached, by means of a spacer, to an interior vertical jamb.

13. The door frame of claim 6, wherein both of the exterior vertical jambs are attached, by means of a spacer, to an interior vertical jamb.

14. The door frame of claim 6, wherein the measurements which are marked to indicate a cutting area on the frame are positioned such that if a cut is made at the position of the measurement, and the cut proceeds down the entire side of the door frame, a previously interior vertical jamb will be converted to an exterior vertical jamb.

15. The door frame of claim 6, wherein the plurality of horizontal crossbeams connecting the leftmost vertical jamb present on the right side of the door frame to the rightmost vertical jamb present on the left side of the door frame comprises at least four horizontal crossbeams.
